(19) United States
(12) Patent Application Publication
(10) Pub. No.: US 2013/0253860 A1
(43) Pub. Date: Sep. 26, 2013

(54) CLOCK FAILURE DETECTION APPARATUS AND METHOD, AND TIMING CONTROLLER OF LIQUID CRYSTAL DISPLAY INCLUDING THE CLOCK FAILURE DETECTION APPARATUS

(71) Applicant: CORE LOGIC INC., Seoul (KR)

(72) Inventors: Young Dong KIM, Seoul (KR); Bora KIM, Seoul (KR)

(73) Assignee: CORE LOGIC INC., Seoul (KR)

(21) Appl. No.: 13/847,806

(22) Filed: Mar. 20, 2013

(30) Foreign Application Priority Data
Mar. 21, 2012 (KR) 10-2012-0028933

(51) Int. Cl. G02F 1/13

(52) U.S. Cl. CPC G02F 1/1309
USPC 702/58

(57) ABSTRACT

Embodiments of the invention relate to a clock failure detection apparatus and method, and a timing controller of a liquid crystal display including the clock failure detection apparatus, and more particularly to a clock failure detection apparatus and method, by which a failed driving state of a liquid crystal display can be accurately and reliably detected and determined by monitoring a low voltage differential signaling (LVDS) clock using a clock of an oscillator for generating clocks of a predetermined frequency in a timing controller of the liquid crystal display when a clock failure is detected in operation of the liquid crystal display, and a timing controller including the clock failure detection apparatus.

### CROSS-REFERENCE TO RELATED APPLICATION

This application claims priority to Korean Patent Application No. 10-2012-0028933 filed on 21 Mar., 2012, and all the benefits accruing therefrom under 35 U.S.C. §119, the contents of which is incorporated by reference in its entirety.

### BACKGROUND

1. Technical Field

The present invention relate to a clock failure detection apparatus and method, and a timing controller of a liquid crystal display including the clock failure detection apparatus, and more particularly, to a clock failure detection apparatus and method, by which a failed driving state of a liquid crystal display can be accurately and reliably detected and determined by monitoring a low voltage differential signaling (LVDS) clock using a clock of an oscillator for generating clocks of a predetermined frequency in a timing controller of the liquid crystal display when a clock failure is detected in operation of the liquid crystal display, and a timing controller including the clock failure detection apparatus.

2. Description of the Related Art

As well known in the art, a liquid crystal display (LCD) includes a plurality of source drive integrated circuits (ICs) for supplying a data voltage to data lines of an LCD panel, a plurality of gate drive ICs for sequentially supplying a gate pulse (or scan pulse) to gate lines of the LCD panel, and a timing controller (TCON) for controlling the drive ICs.

The timing controller (TCON) generates a signal for driving the LCD and modulates video data according to formats of components used in the LCD. One example of a conventional technique related to a timing controller of a liquid crystal display is disclosed in detail in Korean Patent Publication No. 10-2010-0068936A.

Referring to FIG. 1, a timing controller 110 outputs signals for controlling source driver ICs 120 and gate driver ICs 130 for driving a liquid crystal display 100.

As shown in FIG. 2, the timing controller 110 serves to map or modulate R/G/B display data sent from a system providing signals to be displayed in the liquid display 100 such that the R/G/B display data are suited to a pixel structure of the liquid display 100.

As shown in FIG. 2, the timing controller 110 processes data received by a signal reception unit Rx 112 such that the data are suited for a drive interface of the liquid crystal display in a data control block unit 113, and then outputs the processed data through a signal transmission unit Tx 114. In addition, the timing controller 110 includes a control signal generator 115, and also serves to generate and provide various control signals for driving the liquid crystal display through the control signal generator 115.

When the timing controller 110 receives an abnormal input signal (or data), a failure/safety detector 116 of the timing controller 110 detects the abnormal input signal and generates data and control signals corresponding to a failure mode to output the data and the control signal.

If an input signal received by the timing controller 110 is abnormal, a screen based on the abnormal data is abnormally displayed on the liquid crystal display.

Thus, when an abnormal signal is input to the timing controller 110, the screen is promptly converted to allow a black or specific pattern to be displayed on the liquid crystal display to indicate that the screen is in a failure mode.

In detection or determination of an input state of such an abnormal signal, it is actually most important to determine whether a low voltage differential signaling (LVDS) clock is normally input.

That is, when an LVDS clock is not input, it is impossible to process video data, and it is very important in design of the timing controller to allow a specific display in a failure mode.

In the related art, in design of a timing controller, it is determined whether a clock is normally input by monitoring a lock signal of a phase locked loop (PLL). However, when normal input of a clock is determined based on a lock signal of the phase locked loop, there is a problem in that determination accuracy can be deteriorated.

### BRIEF SUMMARY

An aspect of the present invention is to provide a clock failure detection apparatus and method, by which a failed driving state of a liquid crystal display can be accurately and reliably detected and determined by monitoring a low voltage differential signaling (LVDS) clock using a clock of an oscillator for generating clocks of a predetermined frequency in a timing controller of the liquid crystal display when a clock failure is detected in operation of the liquid crystal display, and a timing controller including the clock failure detection apparatus.

In accordance with one aspect of the invention, a clock failure detection apparatus includes: a clock divider which divides and outputs a reference clock generated by an oscillator; a counter which counts a clock of a low voltage differential signal (LVDS) input to a liquid crystal display; a flag signal generator which generates a flag signal using divided outputs output from the clock divider; a storage unit which stores a N-th (N: an integer) clock count value output from the counter according to the flag signal; and a comparison unit which compares an (N+1)-th clock count value stored in the storage unit and the N-th clock count value according to the flag signal, and outputs a failure detection signal for the low voltage differential signal according to the comparison result.

The storage unit may include a first storage unit which stores the N-th clock count clock, and a second storage unit which stores the (N+1)-th clock count value.

A clock count value of the low voltage differential signal may be stored in the first and second storage units at a time point when the flag signal is high.

The comparison unit may include a comparator and a NAND gate.

The comparison unit may include an exclusive OR gate.

The divider may include a D flip-flop.

The divider may divide a clock into eight parts.

Each of the first and second storage units may include flip-flops, and the second storage unit may be connected in series to a rear end of the first storage unit.

In accordance with another aspect of the invention, a clock failure detection method includes: dividing and outputting a reference clock generated by an oscillator; counting a clock of a low voltage differential signal (LVDS) input to a liquid crystal display; generating a flag signal using divided outputs obtained through the division of the reference clock; storing an N-th (N: an integer) clock count value generated in counting the clock according to the flag signal; and comparing an (N+1)-th clock count value with the N-th clock count value stored in the storing operation according to the flag signal, and outputting a failure detection signal for the low voltage differential signal according to the comparison result.

According to the present invention, in detection of a clock failure signal of an LCD, the apparatus and method can accurately and reliably detect and determine a failed driving state of the LCD by monitoring a low voltage differential signaling (LVDS) clock using a clock of an oscillator for generating clocks of a predetermined frequency in a timing controller of the LCD.

### BRIEF DESCRIPTION OF THE DRAWINGS

The above and other aspects, features, and advantages of the present invention will become apparent from the detailed description of the following embodiments in conjunction with the accompanying drawings, in which:

FIG. 1 is a view of a general liquid crystal display;

FIG. 2 is a block diagram of a timing controller (TCON) of a general liquid crystal display;

FIG. 3 is a block diagram of a main part of a timing controller applied to a drive control unit of a liquid crystal display according to one embodiment of the present invention;

FIG. 4 is a block diagram of a clock failure detector of a liquid crystal display according to one embodiment of the present invention;

FIG. 5 is a flowchart of a clock failure detection method according to one embodiment of the present invention; and

FIGS. 6 to 8 are timing diagrams showing operations of a timing controller of a liquid crystal display including the clock fail detection apparatus according to the embodiment of the present invention.

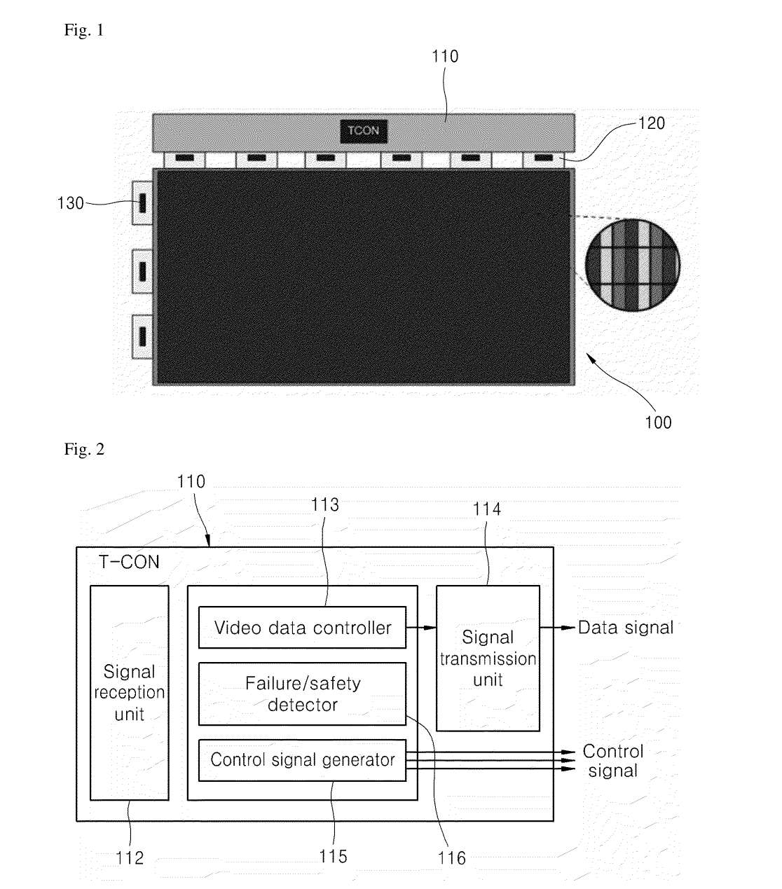

### DETAILED DESCRIPTION

Embodiments of the present invention will now be described in detail with reference to the accompanying drawings. It should be understood that the present invention is not limited to the following embodiments and may be embodied in different ways, and that the embodiments are given to provide complete disclosure of the invention and to provide thorough understanding of the invention to those skilled in the art. Descriptions of details apparent to those skilled in the art will be omitted for clarity.

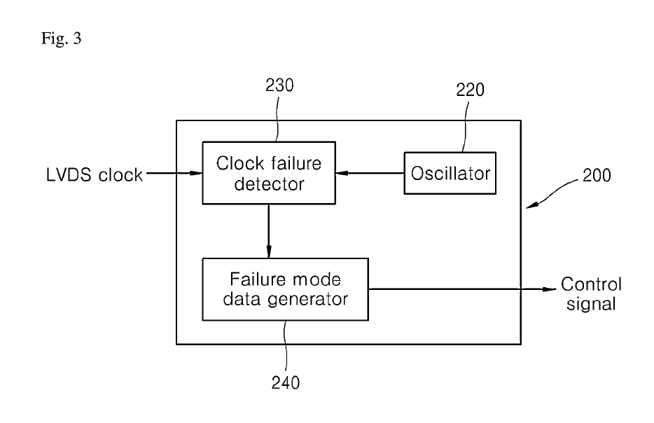

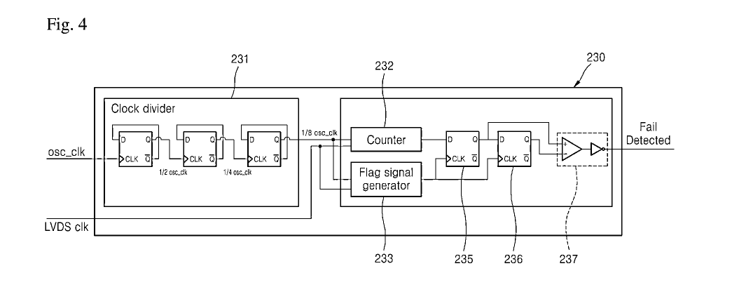

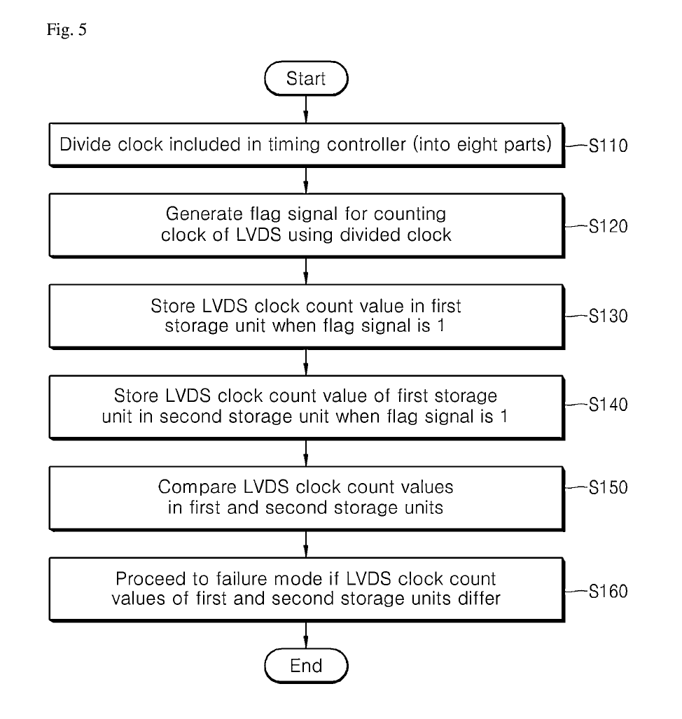

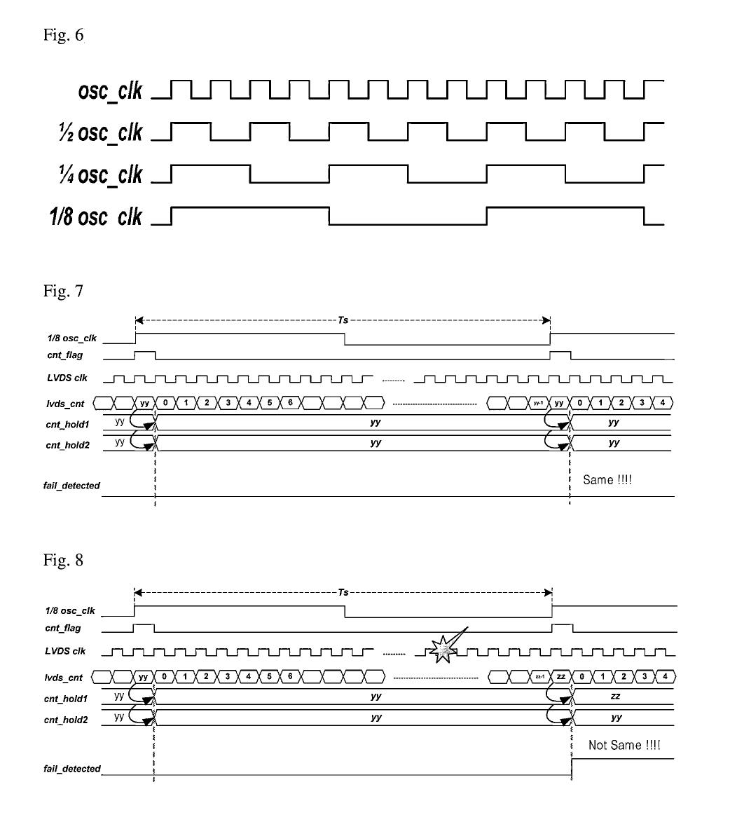

FIG. 3 is a block diagram of a main part of a timing controller applied to a drive control unit of a liquid crystal display according to one embodiment, FIG. 4 is a block diagram of a clock failure detector of a liquid crystal display according to one embodiment, and FIG. 5 is a flowchart of a clock failure detection method according to one embodiment.

Referring to FIGS. 3 and 4, a clock failure detection apparatus 200 according to the present invention may be provided to a timing controller of an LCD, and may include a clock failure detector 230, a failure mode data generator 240, and an oscillator 220.

The oscillator 220 may generate and output a reference clock osc_clk used in the LCD.

The reference clock osc_clk output from the oscillator 220 may be input to the clock failure detector 230.

The clock failure detector 230 may include a clock divider 231, a counter 232, a flag signal generator 233, storage units 235, 236, and a comparison unit 237. The storage units 235, 236 may include a first storage unit 235 and a second storage unit 236.

The clock divider 231 may divide a reference clock osc_clk output from the oscillator 220 and outputs the divided clock.

For example, referring to FIG. 4, the clock divider 231 may divide the reference clock osc_clk into eight parts and output the divided clock (⅛ osc_clk). Here, the clock divider 231 may include three D flip-flops, but the present invention is not limited thereto. In addition, although the clock divider 231 is described as dividing the reference clock osc_clk into eight parts, the present invention is not limited thereto.

Referring to FIG. 5, in dividing operation of the clock divider 231, the reference clock osc_clk output from the oscillator 220 may first be divided into two parts by the first flip-flop of the clock divider 231. Also, the clock (½ osc clk) divided into two parts may be divided into a clock (¼ osc_clk) divided into four parts and a clock (⅛ osc_clk) divided into eight parts by the second and third flip-flops, respectively, to be output (S110).

The flag signal generator 233 may receive the clock ⅛ osc_clk divided into eight parts by the clock divider 231, and generate a flag signal cnt_flag using the clock ⅛ osc_clk divided into eight parts.

In other words, the flag signal generator 233 may receive the clock ⅛ osc_clk divided into eight parts and the original clock, for example, a low voltage differential signal (LVDS) input to the LCD, and generate a flag signal cnt_flag such that the counter 232 described below can count an LVDS clock using the two clock signals. (S120: FIG. 5)

The flag signal cnt-flag may be used to reset the LVDS clock count. As will be described below, when the flag signal cnt_flag is high, it may be used to store an LVDS clock counter value in the first storage unit 235.

Further, the flag signal cnt_flag may be used to store the LVDS clock counter value, which is stored in the first storage unit 235, in the second storage unit 236. To allow the LVDS clock counter value stored in the first storage unit 235 to be stored in the second storage unit 236, it is desirable that the flag signal cnt_flag become high.

The flag signal generator 233 generates a flag signal at a start point of a period (Ts) section of the clock ⅛ osc_clk divided into eight parts, and applies the flag signal to the D flip-flops corresponding to the first and second storage units 235, 236 at a rear side. That is, the flag signal cnt_flag is input to a clock terminal of the D flip-flop.

The counter 232 counts the LVDS clock input from the liquid crystal display with reference to the flag signal.

The LVDS clock value LVDS_cnt counted by the counter 232 is stored in the first D flip-flop 235 cnt_hold1 connected to a rear end of the counter 232 when the flag signal is high. (S130)

The LVDS clock value LVDS_cnt stored in the first D flip-flop 235 is stored in the second D flip-flop 236 cnt_hold2 connected to a rear end of the first D flip-flop 235 when the flag is high (S140).

When the LVDS clock LVDSclk normally enters the clock failure detector 230, the LVDS clock counter value cnt_hold1 in the first D flip-flop 235 and the LVDS clock counter value cnt_hold2 in the second D flip-flop 236 coincide with each other.

That is, the comparison output unit 237 of the clock failure detector 230 compares the LVDS clock counter value cnt_hold1 in the first D flip-flop 235 and the LVDS clock counter value cnt_hold2 in the second D flip-flop 236, and if the LVDS clock values are different from each other, a failure mode signal is output, allowing the LCD to be driven in a failure mode (S150 and S160).

Although the comparison unit 237 is illustrated as including a comparator and a NAND gate in FIG. 5, the present invention is not limited thereto and may be variously configured by taking a design into account. For example, an exclusive-OR gate may be provided to reduce the number of components.

FIG. 7 shows one example in which the LVDS clock counter value cnt_hold1 in the first D flip-flop 235 is the same as the LVDS clock counter value cnt_hold2 in the second D flip-flop 236 and yy data are stored in both the first and second D flip-flops 235, 236 in the same way.

FIG. 8 shows one example in which the LVDS clock counter value cnt_hold1 in the first D flip-flop 235 is different from the LVDS clock counter value cnt_hold2 in the second D flip-flop 236.

That is, if the LVDS clock is neither changed halfway nor input temporarily in FIG. 8, zz data are stored in the first D flip-flop 235 and yy data are still in the second D flip-flop 236, so that the LVDS clock values stored in the D flip-flops 235, 236 become different, thereby allowing the clock failure detector to detect a failure situation of the liquid crystal display and to inform a rear end thereof of the failure situation.

Although two flip-flops are provided as the storage units for storing LVDS clock values herein, the present invention is not limited thereto and more than two flip-flops may be provided for a longer monitoring section with respect to LVDS clock values.

Although some embodiments have been described herein, it should be understood by those skilled in the art that these embodiments are given by way of illustration only, and that various modifications, variations, and alterations can be made without departing from the spirit and scope of the invention. Therefore, the scope of the invention should be limited only by the accompanying claims and equivalents thereof.

What is claimed is:

1. A clock failure detection apparatus comprising:
a clock divider which divides and outputs a reference clock generated by an oscillator;
a counter which counts a clock of a low voltage differential signal (LVDS) input to a liquid crystal display;
a flag signal generator which generates a flag signal using divided outputs output from the clock divider;
a storage unit which stores an N-th (N being an integer) clock count value output from the counter according to the flag signal; and
a comparison unit which compares a (N+1)-th clock count value stored in the storage unit and the N-th clock count value according to the flag signal and outputs a failure detection signal for the low voltage differential signal according to the comparison result.

2. The clock failure detection apparatus according to claim 1, wherein the storage unit comprises a first storage unit which stores the N-th clock count clock, and a second storage unit which stores the (N+1)-th clock count value.

3. The clock failure detection apparatus according to claim 2, wherein a clock count value of the low voltage differential signal is stored in the first and second storage units at a time point when the flag signal is high.

4. The clock failure detection apparatus according to claim 1, wherein the comparison unit comprises a comparator and a NAND gate.

5. The clock failure detection apparatus according to claim 1, wherein the comparison unit comprises an exclusive OR gate.

6. The clock failure detection apparatus according to claim 1, wherein the divider comprises a D flip-flop.

7. The clock failure detection apparatus according to claim 1, wherein the divider divides a clock into eight parts.

8. The clock failure detection apparatus according to claim 2, wherein each of the first and second storage units comprises flip-flops, and the second storage unit is connected in series to a rear end of the first storage unit.

9. A clock failure detection method comprising:
dividing and outputting a reference clock generated by an oscillator;
counting a clock of a low voltage differential signal (LVDS) input to a liquid crystal display;
generating a flag signal using divided outputs obtained through the division of the reference clock;
storing an N-th (N being an integer) clock count value generated in the counting a clock according to the flag signal; and
comparing an (N+1)-th clock count value with the N-th clock count value stored in the storing operation according to the flag signal, and outputting a failure detection signal for the low voltage differential signal according to the comparison result.

11. The clock failure detection method according to claim 9, wherein, in the dividing a clock, the clock is divided into eight parts.
